(19) United States
(12) Patent Application Publication
(10) Pub. No.: US 2025/0331543 A1
(43) Pub. Date: Oct. 30, 2025

(54) SUGAR SUBSTITUTE COMPOSITION AND A PROCESS FOR PREPARING THE SAME

(71) Applicant: CENTURIA GLOBAL TRADE MART LLP, Jaipur (IN)

(72) Inventors: Nihar KOTHARI, Jaipur (IN); Siddharth KOTHARI, Jaipur (IN); Dipti KOTHARI, Jaipur (IN); Daslukuntey B Anantha NARAYANA, Bangalore (IN); Rinka BANERJEE, Bangalore (IN); Meera SRINIVASAN, Chennai (IN)

(21) Appl. No.: 18/875,328

(22) PCT Filed: Jun. 2, 2023
(86) PCT No.: PCT/IN2023/050520

§ 371 Date: Dec. 16, 2024

(30) Foreign Application Priority Data
Jun. 15, 2022 (IN) 202211034379

(51) Int. Cl. A23L 27/30; A23L 27/10; A23P 10/20; A23P 10/43

(52) U.S. Cl. CPC A23L 27/34; A23L 27/10; A23P 10/20; A23P 10/43

(57) ABSTRACT

The present disclosure relates to a sugar substitute composition comprising components selected from at least one regular sugar, maple syrup, and honey, at least one herb extract, at least one soluble fiber, at least one natural sweetener, at least one sugar alcohol, at least one anti-caking agent, and at least one vitamin and minerals. The composition substantially reduces the ill-effects of consuming regular sugar.

### FIELD OF THE INVENTION

The present disclosure relates to a sugar substitute composition and a process for preparing the same.

### BACKGROUND OF THE INVENTION

Sugar is a popular sweetening additive in human food preparation. By sugar it is understood to be sucrose but also includes other calorie rich sweetening additives such as glucose, fructose, and high fructose corn syrups. Fructose is the most lipophilic carbohydrate. As a result of its unique metabolic properties, fructose may be particularly harmful. Diets rich in fructose can rapidly produce all key features of the metabolic syndrome (Hannou, et al, 2018 Fructose metabolism and metabolic disease, The Journal of Clinical Investigation). In case of fructose, 100 percent of the metabolic burden rests on the liver. Fructose is turned into free fatty acids and triglycerides, which gets stored as fat. The fatty acids created during the fructose metabolism accumulate as fat droplets in the liver and skeletal muscle tissues, causing insulin resistance and non-alcoholic fatty liver disease (NAFLD). Insulin resistance progresses to metabolic syndrome and type II diabetes.

Popular feeding habits tend to show an overconsumption of sugar. However, among others due to its high calorie content, high uptake of sugar is not recommended for dietary reasons. The most common adverse health effects of sugar are tooth decay and obesity. The rapid introduction of high fructose corn syrup into the food supply in the 1970s, particularly in soft drinks, has been recognized as an important factor contributing to the obesity epidemic that has swept the world in last 30 years.

Further, the threat of diabetes has also tripled in the last 30 years due to our unhealthy food habits and lack of exercise. Environmental and lifestyle changes resulting from industrialization leads to epidemic of type II diabetes. A high level of glucose in the blood is harmful. Even though the symptoms are not immediately severe, over time, uncontrolled high blood sugar levels can damage the smaller blood vessels, leading to complications including irreversible damage to the eyes and kidneys. Nerves can also be damaged, which can affect internal organs as well as the ability to feel sensations and pain. Uncontrolled diabetes increases the risk of cardiovascular diseases such as heart attack and stroke. Any fructose-based solution is a bigger evil. Increased sugar consumption is increasingly considered to be a contributor to the worldwide epidemics of obesity and diabetes and their associated cardiometabolic risks. Using synthetic sweeteners and natural sweeteners has been the practice for some years.

Most of the synthetic sweeteners are used as substitutes to sugar as they impart low calories but eventually make you consume more of these products. Examples of these commonly used artificial sweeteners include, such as but not limited to, aspartame, saccharin, acesulfame, neotame, and sucralose. These artificial sweeteners are although approved by the Food and Drug Administration (FDA) but are not healthy alternatives. Studies suggest existence of gradient risk after many years of consumption of these artificial sweeteners. Further, these artificial sweeteners have also been reported to be associated with an increased risk of weight gain, obesity, and type II diabetes (refer Sanyaolu et al, 2018, Artificial sweeteners and their association with Diabetes: A review, J Pub Health Catalog 2018 Volume 1 Issue 4).

Natural sweeteners are also an alternative but not much healthy compared to sucrose as most natural sweeteners eventually get metabolized to glucose and fructose like our table sugar. Other natural sweeteners like Thaumatin, Miraculin, and Monkfruit cannot be used at high levels as they give a metallic/bitter aftertaste and are not cost viable. Further, sugar alcohols if consumed in an exceeding amount lead to gastrointestinal problems.

Some of the sweeteners available in the market impart a different taste than natural sugar, thereby leading to compositions that mask the taste of said sweeteners. Currently, a lot of compositions are available in the market which act as a sugar substitute but most of them are equal weight sugar substitutions. Said otherwise, the consumption of these compositions is in same amounts as that of regular sugar but resulting in no or less calories as the components of such compositions are not digested by the body.

Owing to the foregoing problems, various sugar compositions have been formulated which include substantial amounts (>90%) of additives that have no nutrients and are not easily digestible by the human body. Further, these compositions also do not contain any vitamins or minerals and are either in the form of a gel or just a powdered blend of all the components. This makes it hard to get the right amount of sugar substitute to be used.

Therefore, there is required a sugar substitute composition and a process for preparing such sugar substitute composition which addresses at least the aforementioned problems.

### SUMMARY OF THE INVENTION

In one aspect, the present invention provides a sugar substitute composition

In another aspect, the present invention provides a method for preparing the sugar substitute composition.

### DESCRIPTION OF THE INVENTION

The present invention discloses a sugar substitute composition which substantially reduces the ill-effects of consuming regular sugar.

In an embodiment, the sugar substitute composition comprises:
(a) at least one selected from regular sugar, maple syrup, and honey,
(b) at least one herb extract,
(c) at least one soluble fiber,
(d) at least one natural sweetener,
(e) at least one sugar alcohol,
(f) at least one anti-caking agent, and
(g) at least one vitamin and minerals.

In one embodiment, the sugar substitute composition comprises:
(a) 70 wt. % to 99.97 wt. % of at least one selected from regular sugar, maple syrup, and honey, and
(b) 0.03 wt % to 20 wt % of at least one selected from herb, soluble fiber, natural sweetener, sugar alcohol, anti-caking agent, vitamins and minerals,
wherein the wt. % is based on the total weight of the composition.

In one embodiment, the sugar substitute composition comprises:
(a) 70 wt. % to 99.97 wt. % of at least one selected from regular sugar, maple syrup, and honey, and
(b) 0.03 wt % to 10 wt % of at least one selected from herb, soluble fiber, natural sweetener, sugar alcohol, anti-caking agent, vitamins and minerals,
wherein the wt. % is based on the total weight of the composition.

In one embodiment, the sugar substitute composition comprises:
(a) 70 wt. % to 99.97 wt. % of at least one selected from regular sugar, maple syrup, and honey, and
(b) 0.03 wt % to 5 wt % of at least one selected from herb, soluble fiber, natural sweetener, sugar alcohol, anti-caking agent, vitamins and minerals,
   wherein the wt. % is based on the total weight of the composition.

In one embodiment, the sugar substitute composition comprises:
(a) 70 wt. % to 99 wt. % of at least one selected from regular sugar, maple syrup, and honey,
(b) 0.05 wt. % to 0.7 wt. % of at least one natural sweetener, and
(c) 1.0 wt. % to 15.0 wt. % of at least one soluble fiber,
   wherein the wt. % is based on the total weight of the composition.

In one embodiment, the sugar substitute composition comprises:
(a) 70 wt. % to 95 wt. % of at least one selected from regular sugar, maple syrup, and honey,
(b) 0.05 wt. % to 0.7 wt. % of at least one natural sweetener, and
(c) 1.0 wt. % to 15.0 wt. % of at least one soluble fiber,
   wherein the wt. % is based on the total weight of the composition.

In the present context, “sugar substitute composition” refers to the composition that can replace the regular sugar.

In the present context, “regular sugar” refers to sulfur-free processed sugar and/or unrefined or partially refined sugar. The sulfur-free sugar, as the name suggests, does not contain any sulfur residues that are otherwise present in the conventionally cleaned sugars. The sulfur-free processed sugar may be in the form of crystals, Boora sugar, colored with molasses and mixtures thereof. Suitable examples of unrefined or partially refined sugar include, such as but not limited to, brown sugar, powdered jaggery, and raw sugar.

Honey is a natural product derived from the digestive conversion of flower nectar to simple sugars by the common honeybee. Honey is composed of glucose, fructose, water, minerals, organic acids, and a small amount of proteinaceous material. Natural honey is comprised of multiple nutrients including carbohydrates, proteins, vitamins, and minerals.

Maple syrup is obtained from boiling the xylem sap of maple trees. In cold climates, the maple trees store starch in their trunks and roots before the winter and the starch is converted to sugar that rises in the sap in the spring. Maple trees can be tapped by boring holes into their trunks and collecting the exuded sap. The sap is processed by heating to evaporate much of the water, leaving the concentrated syrup.

The sugar substitute composition further comprises one or more selected from the group consisting of anti-caking agents, regular sugar, prebiotic fibers, sugar alcohols, herb extracts, and vitamins and minerals.

In a preferred embodiment, the sugar substitute composition comprises:
(a) 70 wt. % to 99 wt. % of at least one selected from regular sugar, maple syrup, and honey,
(b) 0.05 wt. % to 0.3 wt. % of the at least one natural sweetener,
(c) 1.0 wt. % to 15.0 wt. % of the at least one soluble fiber,
(d) 5.0 wt. % to 15.0 wt. % of the at least one sugar alcohol,
(e) 0.05 wt. % to 0.3 wt. % of the anti-caking agent,
(f) 0.05 wt. % to 0.5 wt. % of the at least one herb extract, and
(g) 0.01 wt. % to 0.6 wt. % of the at least one vitamin and minerals,
wherein the wt. % is based on the total weight of the composition.

In a preferred embodiment, the sugar substitute composition comprises:
(a) 70 wt. % to 90 wt. % of at least one selected from regular sugar, maple syrup, and honey,
(b) 0.05 wt. % to 0.3 wt. % of the at least one natural sweetener,
(c) 1.0 wt. % to 15.0 wt. % of the at least one soluble fiber,
(d) 5.0 wt. % to 9.0 wt. % of the at least one sugar alcohol,
(e) 0.05 wt. % to 0.3 wt. % of the anti-caking agent,
(f) 0.05 wt. % to 0.2 wt. % of the at least one herb extract, and
(g) 0.2 wt. % to 0.6 wt. % of the at least one vitamin and minerals,
wherein the wt. % is based on the total weight of the composition.

In a preferred embodiment, the sugar substitute composition comprises:
(a) 80 wt. % to 95 wt. % of at least one selected from regular sugar, maple syrup, and honey,
(b) 0.3 wt. % to 0.7 wt. % of the at least one natural sweetener,
(c) 4.0 wt. % to 8.0 wt. % of the at least one soluble fiber, and
(d) 0.1 wt. % to 0.4 wt. % of the at least one herb extract,
wherein the wt. % is based on the total weight of the composition.

In one embodiment, the sugar substitute composition comprises:
(a) 99.75 wt % Sugar; and
(b) 0.25 wt % herbs;
wherein the wt. % is based on the total weight of the composition.

In yet another embodiment, the sugar substitute composition comprises:
(a) 99.97 wt % Sugar; and
(b) 0.03 wt % of micronutrient premix;
wherein the wt. % is based on the total weight of the composition.

In yet another embodiment, the sugar substitute composition comprises:
(a) 97.20 wt % Sugar;
(b) 0.50 wt % herbs;
(c) 2 wt % soluble fiber; and
(d) 0.30 wt % natural sweetener;
wherein the wt. % is based on the total weight of the composition.

In yet another embodiment, the sugar substitute composition comprises:
(a) 97.1 wt % Sugar;
(b) 0.25 wt % herbs;
(c) 2.125 wt % soluble fiber;
(d) 0.30 wt % natural sweetener;
(e) 0.20 wt % anti-caking agent; and
(f) 0.096 wt % minerals;
wherein the wt. % is based on the total weight of the composition.

In yet another embodiment, the sugar substitute composition comprises:
(a) 91.72 wt % Sugar;
(b) 0.45 wt % herbs;
(c) 2.13 wt % soluble fiber;
(g) 0.30 wt % natural sweetener;
(h) 5 wt % sugar alcohol;
(i) 0.20 wt % anti-caking agent; and
(d) 0.20 wt % minerals;
wherein the wt. % is based on the total weight of the composition.

The anti-caking agents, as disclosed herein, prevent the formation of lumps making the sugar substitute composition manageable for packaging, transport, and for use by end consumer. There are two types of anti-caking agents-manufactured or man-made and natural anticaking agents. Most of the anti-caking agents are made from synthetic substances such as silicon dioxide or magnesium and calcium stearates (solid saturated fatty acids). However, there are many anti-caking agents that come from natural sources. Some of the natural anticaking agents include kaolin, talc, and bentonite.

Man-made anticaking agents are manufactured from chemicals and other artificial substances like silicates, acids etc. Suitable examples of manufactured anti-caking agents include, such as but not limited to, calcium silicate, magnesium carbonate, sodium aluminosilicate, silicon dioxide, magnesium stearate, calcium stearate, sodium silicate and the likes.

Suitable natural sweeteners include, such as but not limited to, stevia extract. Stevia extract is known to be a source of steviol glycosides which are responsible for the sweet taste of the leaves of the stevia plant (Stevia rebaudiana). Steviol glycosides range in sweetness from 40 to 300 times sweeter than sucrose and are also characterized as being heat-stable, pH stable, and non-fermentable.

Suitable soluble fibers include, such as but not limited to, natural gums, and prebiotic fibers, for example polydextrose. Examples of natural gums include, such as but not limited to, gum Arabic, gum acacia, gum tragacanth, gum ghatti and the likes. Other soluble fibers such as the likes of inulin, and plant-based fiber, such as that obtained from fenugreek or methi seeds can also be used in the present composition.

Suitable sugar alcohols can be characterized by the general formula HO—CH₂—(CH—OH)ₙ—CH₂—OH, wherein n is typically from 1 to 22. For example, when n=2, the sugar alcohol can be erythritol, threitol, etc. For example, when n=3, the sugar alcohol can be arabitol, xylitol, ribitol, etc. Similarly, when n=4, the sugar alcohol can be mannitol, sorbitol, etc. The most common sugar alcohols have 5 or 6 carbon atoms in their structure, wherein n is 3 or 4, respectively. While sugar alcohols occur naturally, and can be isolated from plants, most often they are obtained by the selective hydrogenation of sugars. An alternative method of producing sugar alcohols is from fermentation of sugars. Herein, sugars refer to aldoses or ketoses forms of a sugar.

Suitable herbs or herb extracts include, such as but not limited to, licorice, punarnava, arjuna and the likes. Licorice or liquorice is the common name of Glycyrrhiza glabra, a flowering plant of the bean family Fabaceae, from the root of which a sweet, aromatic flavoring can be extracted. Punarnava generally refers to roots of Boerhavia diffusa plant. It is also called as Red Spiderling in English. It belongs to Nyctaginaceae family and Boerhavia L. (spiderling) genus. Terminalia Arjuna commonly known as Arjun tree, Arjuna, Koha, Kahu, Arjan, White Marudah, White Murdh, Arjuna, Myrobalan, Orjun, Yerra maddi, Sadada and Sadaru is a tree of Combretaceae family and genus Terminalia. Some of the other preferred examples include Ashwagandha, Brahmi, Tulsi, Garcinia Cambogia, Gymnema Sylvestre Cinnamon, Black Jeera, Black Pepper, Turmeric, Cumin, Lemon grass, Garlic etc.

Suitable minerals include, such as but not limited to, calcium, magnesium, potassium, chromium, phosphorus, and the likes. Further, suitable vitamins include, such as but not limited to, vitamins C, A, K, E and B complex vitamins, and their esters or salts. Minerals like iron and zinc and trace elements such as chromium, selenium, manganese can also be added in the present composition. Some of the other preferred examples include vitamin B9, vitamin B12 and vitamin D, magnesium oxide, potassium, phosphorus, Magnesium Chromium premix etc.

Another aspect of the present disclosure relates to a method for preparing the sugar substitute composition, as described herein.

In one embodiment, the method comprises mixing all the ingredients in the specified wt. % based on the total weight of the composition.

In yet another embodiment, the method comprises at least the steps of mixing the ingredients mentioned hereinabove followed by spraying to obtain the sugar substitute composition.

In an embodiment, the method comprises at least the steps of:
(A) dissolving the at least one soluble fiber in water to obtain a solution,
(B) adding the at least one herb extract, the at least one vitamin and minerals, the at least one natural sweetener, and the anti-caking agent to the solution obtained in step (A),
(C) mixing the solution obtained in step (B) with at least one selected from regular sugar, maple syrup, and honey, and the at least one sugar alcohol to obtain a suspension, and
(D) spraying the suspension obtained in step (C) to obtain the sugar substitute composition.

In another embodiment, the method comprises at least the steps of:
(A) mixing the at least one natural sweetener and the at least one herb extract to obtain a mixture,
(B) adding the at least one soluble fiber to the mixture obtained in step (A), (C) mixing at least one selected from regular sugar, maple syrup, and honey with the mixture obtained in step (B) to obtain a suspension, and
(D) spraying or sprinkling the suspension obtained in step (C) to obtain the sugar substitute composition.

In an embodiment, the addition of one or more ingredients mentioned hereinabove can be done logarithmically. In the present context, “logarithmic” refers to an incremental manner of addition of one or more ingredients. Logarithmic addition ensures uniform mixing of the ingredients.

In another embodiment, the suspension can be sprayed or sprinkled or added logarithmically using suitable means, such as but not limited to, Rota-blender, cone blender, Z-blade mixer, planetary blender, and other equipments. Such equipments are operated until all the requisite quantity of the suspension is completely used off to obtain an effective coating of the ingredients on to the particles of regular sugar.

In another embodiment, the method further comprises the steps of drying the sugar substitute composition at temperatures less than equal to 60° C.

In still another embodiment, the sugar substitute composition can exist in any form, such as but not limited to, pellets, caplets, tablets, dispersible tablets, powder, and the likes. Further, the size and dimension of these forms can be tailor-made depending on the requirement by the consumer. In this regard, the sugar substitute composition can be subjected to known techniques, such as but not limited to, compression, granulation, and the likes.

In an embodiment, the sugar substitute composition can be subjected to granulation by dry slugging and de-granulation to obtain desired granules. Alternately, the sugar substitute can be subjected to wet granulation without use of water. In this regard, solvents such as, but not limiting to, ethanol, Iso-propyl alcohol, liquid glucose, and the likes can be used. The granules thus obtained can be compressed in any of the aforementioned forms.

Yet another aspect of the present disclosure relates to a kit comprising the sugar substitute composition, as described hereinabove, and a package insert.

In an embodiment, the sugar substitute composition can be in any form, such as but not limited to, pellets, caplets, tablets, dispersible tablets, powder, and the likes. Moreover, the sugar substitute composition can be suitably packaged to avoid deterioration of the composition due to, for instance, adverse weather conditions.

In another embodiment, the package insert provides information to a user of the kit. Such information includes, but is not limited to, amount of the composition to be consumed with reference to the amount of regular sugar, sweetness level, health benefits, nutrition level, satiation level, energy, and the likes. The information provided in the package insert can be in the form of words, pictures, and/or the like.

Advantageously, the sugar substitute composition of the present invention is a healthy replacement of the regular sugar and provides the same sweetness level without any bitter taste and/or after effect. Further, the present invention composition does not involves using any artificial sweeteners and still results in up to 50% lower calories at half the dosage of regular sugar for the same sweetness level. Moreover, the presence of soluble fibers in the present invention composition provides for prebiotic effect, i.e., promotes the growth of helpful gut bacteria thereby increasing the gastrointestinal health and potentially providing other health benefits. Furthermore, the present invention composition also minimizes the possibility of ill health effects such as tooth decay and obesity in an individual.

The present invention is also capable of substantially reducing the consumption of regular sugar by providing a higher sweetness level that can be attained by consuming equivalent or even lower amounts of the composition. This substantially reduces the ill-effects of consuming regular sugar as the effective amount of regular sugar being consumed due to the present composition is less than what it would have been otherwise. For instance, the present composition provides for health benefits, such as but not limited to, lower blood sugar spike, low glycemic index, lower glycemic load and the likes.

### EXAMPLE

The following examples are illustrative of the invention but not limitative of the scope thereof:

### Materials and Methods

### Materials

The material used according to the present disclosure include, but not limited to, Polydextrose purchased from Devson Impex Pvt Ltd, Mumbai; STA LITE 90 NG R, made by Tate & Lyle; EID Parry's Refined Raw Sugar from Navkar Sugars, Mumbai; Stevia: Type—Rebaten 97%, purchased from REDA Chemicals India Pvt. Ltd, Thane; Microzon Mineral Premix from Pristine Organics Pvt. Ltd., Bangalore Microzon Micronutrient Premix (Magnesium Chromium Premix) from Pristine Organics Pvt. Ltd., Bangalore. Further herbs (Ashwagandha Dry Extract ratio 10:1, Tulsi Dry Extract ratio 9:1, Brahmi Dry Extract ratio 10:1, Licorice Dry extract ratio 5:1, Punarnava Dry Extract ratio 8:1, Arjuna Dry Extract ratio 10:1, Gudmar (gymneva sylvesta) dry extract ratio 7:1, cinnamon dry extract ratio 4:1, Black Jeera Dry extract ration 10:1, Black Pepper dry extract 10:1, Garcinia Dry Extract) were procured from Konark Herbals & Helathcare, Daman & Diu.

Example 1 (Ayur Plus): Sugar substitute composition enriched with ayurvedic herbs comprising the following as follows:

| | | Daily Dosage | | Daily Dosage | Daily Dosage | QTY used | % | % Used |
|---|---|---|---|---|---|---|---|---|
| | | (Raw herb) | Supplier | Agreed | (g) based | in g per | Dosage | in 20 g |
| Common Name/ | FSSAI | from Ayurvedic | Extract | Raw Herb | on supplier | 100 g | in | daily |
| Description | Limits | Expert/day | Ratio | (g)/Day | extract ratio | of sugar | 100 g | consumption |
| Tulsi leaf | Leaf - | 1-3 gm of | 10:01 | 2 | 0.2 | 0.06 | 30% | 6 |
| extract | 2-5 g | leaves powder. | | | | | | |
| Ashwagandha | Root 3-6 g | 4.5 g | 10:01 | 4.5 | 0.45 | 0.135 | 30% | 6 |
| | (as powder), | | | | | | | |
| | Extract - | | | | | | | |
| | 0.5-1 g | | | | | | | |
| | (as extract) | | | | | | | |
| Brahmi | Extract - | 1-3 g dried | 10:01 | 2 | 0.2 | 0.06 | 30% | 6 |
| | 1-2 g | whole plant | | | | | | |
| | | or LEAVES | | | | | | |

The major chemical composition of the herb (Brahmi) is given in table below:

| Component Amount | (100 gm) | |
|---|---|---|
| Moisture | 88.4 | gm |
| Protein | 2.1 | gm |
| Fat | 0.6 | gm |
| Carbohydrates | 5.9 | gm |
| Crude Fiber | 1.05 | gm |
| Ash | 1.9 | gm |
| Calcium | 202.0 | mg |
| Phosphorus | 16.0 | gm |
| Ascorbic Acid | 63.0 | |
| Nicotinic acid | 0.3 | |
| Iron | 7.8 | mg |
| Energy | 38 | cal |

The following method and process conditions was followed to prepare the sugar substitute composition (Ayur Plus):
Process Parameters
   Coating Drum: RPM_220-230
   Dryer: Drying temperature: 65-70° C., Drying time: 10 min,
   Peristaltic Spraying Pump: pipe tube well thickness 1.5 mm, RPM of Pump 40-42
   Qty of solution sprayed-35.1 ml, Time taken: 165 Sec
   Water—30 ml
Premix (Herbs)-Black Box Preparation in the following quantity:

| Raw Materials | Quantity for 2 Kg |
|---|---|
| sugar | 1995 g |
| herbs | 5.1 |
| Total | 5.1 g 2000.1 g |

Further, the Process Flow to achieve the Ayur Plus sugar substitute composition is as follows:
Weigh (5.1 g) Herbal Premix+Water (30 ml), mix it for 3 min in High Shear Mixer @3000-6000 rpm (till it dissolves completely)
Transfer require quantity of sugar to Coating Drum
Start the Drum, (RPM of Drum 220-230)
Herbal Premix solution is sprayed to the sugar in the drum, intermittently using spraying pump (Flow rate 35.1 ml/165 sec)
A Stream of hot air is passed, using a dryer (65-70° C. for 10 min), till the sugar is dried and free flowing. (Moisture <0.5% of weight)
Pack and Seal once the sugar cools down to room temperature.

Shelf life of the Ayur Plus: The shelf life of the composition is the time period within which the food is safe to consume and/or has an acceptable quality to consumers. The following results were achieved for Ayur Plus:

| | | | | A | B | |
|---|---|---|---|---|---|---|
| | | | | After 90 days in | After 120 days in | |
| | | | | accelerated conditions | accelerated conditions | |
| | | | | equivalent to 9 months | equivalent to 12 months | Specified |
| [symbol] | Phase | Units | Method | in room conditions | in room conditions | Limits |
| MICROBIOLOGICAL | Total viable count | [symbol] | [symbol] | <10 | <10 | <10 |
| | [symbol] | [symbol] | [symbol] | <10 | <10 | <10 |
| | E. coli | [symbol] | [symbol] | Absent | Absent | Absent |
| | [symbol] | [symbol] | [symbol] | Absent | Absent | Absent |
| | Staphylococcus | [symbol] | [symbol] | Absent | Absent | Absent |
| | aureus | | | | | |
| | Yeast | [symbol] | [symbol] | <10 | <10 | <10 |
| | Mold | [symbol] | | <10 | <10 | |
| CHEMICAL | [symbol] | — | [symbol] | [symbol] | [symbol] | Not Specified |
| | [symbol] | g/100 g | [symbol] | [symbol] | [symbol] | Not Specified |
| | [symbol] | g/100 g | [symbol] | [symbol] | [symbol] | Not Specified |
| [symbol] | Appearance in terms | — | [symbol] | [symbol] | [symbol] | [symbol] |
| | of colour | | | | | |
| | Odour | — | [symbol] | [symbol] | [symbol] | [symbol] |
| | Taste | — | [symbol] | [symbol] | [symbol] | [symbol] |
| | Texture/Consistency | — | [symbol] | [symbol] | [symbol] | [symbol] |

| | | | | | |
|---|---|---|---|---|---|
| Result | — | — | Pass | Pass | Pass/Fail |
| Shelf Life Obtained | [symbol] | — | [symbol] | [symbol] | — |

[symbol]

indicates data missing or illegible when filed

### Organoleptic Evaluation: 1—Dislike Very Much; 2—Dislike Moderately; 3—Neither Like nor Dislike; 4—Like Moderately; 5—Like Very Much

Further, Ayur Plus was evaluated for the nutritional value and the following results were achieved:

| | | | | |
|---|---|---|---|---|
| Sr. No | Parameter | Result | Unit | Method |

Chemical Parameters

| | | | | |
|---|---|---|---|---|
| 1 | Carbohydrates | 99.97 | g/100 g | BEE/SOP/FDP/063 |
| 2 | Energy | 399.88 | kcal/100 gm | BEE/SOP/FDP/052 |
| 3 | Fat | <0.05 | g/100 g | FSSAI Manual for Beverages |
| | | | | Sugar and Confectionery |
| | | | | Product, Method |
| | | | | No A.8: 2015 |
| 4 | Protein | <0.1 | g/100 g | IS 7219: 1973, RA 2020 |
| 5 | Added Sugar | 99.89 | g/100 g | IS 6287: 1985, RA 2020 |
| 6 | Total sugar | 99.91 | g/100 g | IS 6287: 1985, RA 2020 |

Advantageously, the healthy Ayur Sugar composition of the present invention is to make the regular sugar healthier by enriching with goodness of three ayurvedic herbs namely Ashwagandha, Tulsi, Brahmi which are known to boost immunity and manage stress and also provides the same sweetness level without any bitter taste and/or after effect.

The disclosed Ayur Plus sugar substitute composition is also capable of providing a same sweetness level like a regular sugar to the user with Zero taste penalty. This substantially reduces the ill-effects of consuming regular sugar. For instance, the present composition provides for health benefits of herbal mixer, such as but not limited to, enhances the body's resilience to stress reduced anxiety, enhanced memory span and concentration, enhanced memory, learning, perception and reaction times, Enhanced learning and controlled abnormal behavior and the likes, promote general health, wellbeing and assist in dealing with the stresses of daily life. Enjoy the taste of sugar with added health benefits by consuming Ayur Plus sugar.

Example 2 (Vita Plus): Sugar substitute composition enriched with minerals and vitamins was prepared using the following amount as follows:

| Raw Materials | Quantity for 2 Kg | |
|---|---|---|
| Refined Sugar | 1999.4 | g |
| Black Box | 0.6 | g |
| Total | 2000 | g |
| Water | 30 | ml |

The following method and process conditions was followed to prepare the sugar substitute composition (Vita Plus): Black box mix was prepared by mixing Iron, Zinc, Vitamin B9, Vitamin B12, Vitamin D under the following process parameters:
Tumbler—RPM 220-240
First mixing time: 5 minutes,
Second mixing time (T2)-10 minutes.

Further, the Process Flow to achieve the Vita Plus sugar composition is as follows:
Mix 25% of the Sugar+MN premix, blend for 5 minutes in Tumbler (RPM 220-240)
Transfer the remaining sugar required to added to the tumbler and blend for 10 minutes. (RPM 220-240)
Pack and Seal once the sugar cools down to room temperature.

Shelf life of Vita Plus: The following results were achieved for Vita Plus:

| | | | | A | B | |
|---|---|---|---|---|---|---|
| | | | | After 90 days in | After 120 days in | |
| | | | | accelerated conditions | accelerated conditions | |
| | | | | equivalent to 9 months | equivalent to 12 months | Specified |
| [symbol] | Phase | Units | Method | in room conditions | in room conditions | Limits |
| MICROBIOLOGICAL | Total viable count | [symbol] | [symbol] | <10 | <10 | <10 |
| | [symbol] | [symbol] | [symbol] | <10 | <10 | <10 |
| | E. coli | [symbol] | [symbol] | Absent | Absent | Absent |
| | [symbol] | [symbol] | [symbol] | Absent | Absent | Absent |
| | Staphylococcus | [symbol] | [symbol] | Absent | Absent | Absent |
| | aureus | | | | | |
| | Yeast | [symbol] | [symbol] | <10 | <10 | <10 |
| | Mold | [symbol] | | <10 | <10 | |
| CHEMICAL | [symbol] | — | [symbol] | [symbol] | [symbol] | Not Specified |
| | [symbol] | g/100 g | [symbol] | [symbol] | [symbol] | Not Specified |
| | [symbol] | g/100 g | [symbol] | [symbol] | [symbol] | Not Specified |
| [symbol] | Appearance in terms | — | [symbol] | [symbol] | [symbol] | [symbol] |
| | of colour | | | | | |
| | Odour | — | [symbol] | [symbol] | [symbol] | [symbol] |
| | Taste | — | [symbol] | [symbol] | [symbol] | [symbol] |
| | Texture/Consistency | — | [symbol] | [symbol] | [symbol] | [symbol] |

| | | | | | |
|---|---|---|---|---|---|
| Result | — | — | Pass | Pass | Pass/Fail |
| Shelf Life Obtained | [symbol] | — | [symbol] | [symbol] | — |

[symbol]

indicates data missing or illegible when filed

### Organoleptic Evaluation: 1—Dislike Very Much; 2—Dislike Moderately; 3—Neither Like nor Dislike; 4—Like Moderately; 5—Like Very Much

Further, Vita plus was evaluated for the nutritional value and the following results were achieved:

| | | | | |
|---|---|---|---|---|
| Sr. No. | Parameter | Result | Unit | Method |

Chemical Parameters

| | | | | |
|---|---|---|---|---|
| 1 | Carbohydrates | 99.93 | g/100 g | BEE/SOP/FDP/053 |
| 2 | Energy | 399.72 | kcal/100 g | BEE/SOP/FDP/052 |
| 3 | Fat | <0.05 | g/100 gm | FSSAI Manual for Beverages |
| | | | | Sugar and Confectionery |
| | | | | Product, Method No A.8: 2015 |
| 4 | Protein | <0.1 | g/100 g | IS 7219: 1973, RA 2020 |
| 5 | Added Sugar | 99.85 | g/100 g | IS 6287: 1985, RA 2020 |
| 6 | Total sugar | 99.85 | g/100 g | IS 6287: 1985, RA 2020 |

Metal Contaminants

| | | | | |
|---|---|---|---|---|
| 7 | Iron | 3.3 | mg/100 gm | BEE/SOP/FDP/044 |
| 8 | Zinc | 2.8 | mg/100 gm | BEE/SOP/FDP/044 |

Vitamins

| | | | | |
|---|---|---|---|---|
| 9 | Vitamin B9 (Folic acid) | 47.9 | μg/100 gm | BEE/SOP/FDP/049 |
| 10 | Vitamin B12 (Cyanocobalamin) | 0.38 | μg/100 gm | BEE/SOP/FDP/048 |
| 11 | Vitamin D (Ergocalciferol) | 2.5 | μg/100 gm | BEE/SOP/FDP/048 |

Advantageously, the healthy Vita Sugar composition of the present invention is to make the regular sugar healthier by enriching with goodness of five essential vitamins and minerals namely Iron, Zinc, Vitamin B9, Vitamin B12 and Vitamin 0 which are known to boost immunity and manage stress and also provides the same sweetness level without any bitter taste and/or after effect.

The Vita Sugar composition is also capable of providing a same sweetness level like a regular sugar to the user with Zero taste penalty. This substantially reduces the ill-effects of consuming regular sugar. For instance, the present composition provides for health benefits of vita mixer, such as but not limited to, enhances the immunity, slows the progression of intermediate and advanced age-related macular degeneration. It also prevents anaemia. It helps in blood formation and provides healthy bones. Thus, by consuming Vita Sugar, the taste of sugar with added health benefits can be enjoyed.

Example 3 (Dia Fit): Sugar substitute composition enriched with natural plant extracts and prebiotic fiber was prepared using the following amount and process parameters as follows:

| Raw Materials | Quantity for 2 Kg | |
|---|---|---|
| Refined Sugar | 1834.4 | g |
| Erythritol | 100 | g |
| Herbs | 9 | g |
| Soluble Fibre | 42.16 | g |
| Stevia | 6 | g |
| Anti Caking Agent | 4 | g |
| Vitamin & Minerals | 4 | g |
| Total | 2000 | g |

### Process Parameters:

Coating Drum: RPM_220-230
Dryer: Drying temperature: 65-70 C, drying time (T1, T2, T3): 10 min, Drying Time (T4)-15 min
Peristaltic Spraying Pump: pipe tube wall thickness 1.5 mm, RPM of Pump 40-42
Quantity of solution sprayed-210 ml, No. of cycles: 4
Water—120 ml

Further, the Process Flow to achieve the Dia Fit sugar composition is as follows:
Gum acacia and 120 ml lukewarm water (60-70 C) were blended in high shear mixture (RPM 3000-6000)
Herb, Stevia, Magnesium chromium and water (28 ml) were blend in High Shear mixer (RPM 3000-6000 for 3 minutes)
Blending both the solutions (wt. 210 ml)
Transfer required Quantity of Sugar and Erythritol to Coating drum
28% of the solution (60 ml) was sprayed (flow rate 60 ml/2 min)
Drying is done for 10 minutes at (65-70 C) using a dryer, till sugar appears to be free flowing (Moisture <0.5% of the weight)
The above steps are repeated for 3 more cycles (23%) keeping moisture of the sugar (post spraying and drying) of the 2^{nd} and 3^{rd} cycles <0.5% of weight, and 4^{th} cycle <0.7% of weight
Polydextrose (260 g/4 min) is blended to the slight moist mixture for 3 minutes (RPM 200-230)
Anticaking agent is added and blended for 3 minutes in Coating Drum (RPM-200-230)
Immediate Packing and Sealing of the product were done in controlled atmosphere.

The resulting Dia Fit sugar substitute composition was evaluated for the nutritional value and the following results were achieved:

| | | | | |
|---|---|---|---|---|
| Sr. No | Parameter | Result | Unit | Method |

Chemical Parameters

| | | | | |
|---|---|---|---|---|
| 1 | Carbohydrates | 99.03 | g/100 g | BEE/SOP/FDP/053 |
| 2 | Dietary Fibre | 7.53 | g/100 g | AOAC 985.29, 21st Edition |
| | | | | 2019 |
| 3 | Energy | 397.12 | Kcal/100 g | BEE/SOP/FDP/052 |
| 4 | Fat | <0.05 | g/100 g | FSSAI Manual for Beverages, |
| | | | | Sugar and Confectionery Product, |
| | | | | Method No A.8: 2015 |
| 5 | Protein | 0.26 | g/100 g | IS 7219: 1973, RA 2020 |
| 6 | Added Sugar | 92.15 | g/100 g | IS 6287: 1985, RA 2020 |
| 7 | Total sugar | 93.28 | g/100 g | IS 8287: 1985 RA 2020 |

Metal Contaminants

| | | | | |
|---|---|---|---|---|
| 8 | Chromium | 0.94 | mg/kg | BEE/SOP/FDP/044 |

Minerals

| | | | | |
|---|---|---|---|---|
| 9 | Sodium | 29.34 | mg/kg | BEE/SOP/FDP/044 |
| 10 | Magnesium | 528.1 | mg/kg | BEE/SOP/FDP/044 |

Advantageously, the Dia Fit sugar composition of natural plant extract was found to reduce the intake of regular sugar yet providing the same level of sweetness and low-calorie intake which will help in fighting diabetes and keep us healthier and in good shape.

Example 4 (Family Fit): Sugar substitute composition enriched with natural plant extracts and prebiotic fiber which reduces the consumption of sugar and helps in managing weight as it is lower in calories compared to regular sugar was prepared using the following amount and process parameters as follows:

| Raw Materials | Quantity for 2 Kg | |
|---|---|---|
| Refined Sugar | 1942 | g |
| Herbs | 5 | g |
| Soluble Fibre | 42.5 | |
| Natural Sweetner | 6 | |
| Anti-Caking Agent | 4 | g |
| Minerals | 1.92 | g |
| Total | 2001.42 | g |

### Process Parameters:

Drum: RPM_220-230
Dryer: Drying temperature: 65-70 C, drying time (T1, T2, T3): 10 min, Drying Time (t4)-15 min
Peristaltic Spraying Pump: pipe tube wall thickness 1.5 mm, RPM of Pump 40-42
Quantity of solution sprayed-210 ml, No. of cycles: 4
Water—120 ml

Further, the Process Flow to achieve the Family Fit sugar composition is as follows:
Gum acacia and 120 ml lukewarm water (60-70 C) were blended in high shear mixture (RPM 3000-6000)
Herb, Stevia, Magnesium chromium and water (28 ml) were blended in High Shear mixer (RPM 3000-6000 for 3 minutes)
Blend both the solutions (wt. 200 ml)
Transfer required Quantity of Sugar to Coating drum
25% of the solution (50 ml) was sprayed (flow rate 50 ml/2 min)
Drying is done for 10 minutes at (65-70 C) using a dryer, till sugar appears to be free flowing (Moisture <0.5% of the weight)
The above steps are repeated for 3 more cycles (23%) keeping moisture of the sugar (post spraying and drying) of the 2^{nd} and 3^{rd} cycles <0.5% of weight, and 4^{th} cycle <0.7% of weight
Polydextrose (200 g/3 min) is blended to the slight moist mixture for 3 minutes (RPM 200-230)
Anticaking agent is added and blended for 3 minutes in Coating Drum (RPM-200-230)
Immediate Packing and Sealing of the product was done in controlled atmosphere.

The resulting Family Fit sugar substitute composition was evaluated for the nutritional value and the following results were achieved:

| | | | | |
|---|---|---|---|---|
| Sr. No | Parameter | Result | Unit | Method |

Chemical Parameters

| | | | | |
|---|---|---|---|---|
| 1 | Carbohydrates | 99.12 | g/100 g | BEE/SOP/FDP/053 |
| 2 | Dietary Fibre | 3.30 | g/100 g | ACAC 985.29, 21st Edition |
| | | | | 2019 |
| 3 | Energy | 397.2 | Kcal/100 g | BEE/SOP/FDP/052 |
| 4 | Fat | <0.05 | g/100 g | FSSAI Manual for Beverages, |
| | | | | Sugar and Confectionery Product, |
| | | | | Method No A.8: 2015 |
| 5 | Protein | 0.18 | g/100 g | IS 7219: 1973, RA 2020 |
| 6 | Added Sugar | 96.51 | g/100 g | IS 6287: 1985, RA 2020 |
| 7 | Total sugar | 97.32 | g/100 g | IS 6287: 1985 RA 2020 |

Minerals

| | | | | |
|---|---|---|---|---|
| 8 | Sodium | 17.12 | mg/kg | BEE/SOP/FDP/044 |
| 9 | Magnesium | 8.49 | mg/kg | BEE/SOP/FDP/044 |

Advantageously, the Family Fit sugar substitute composition of natural plant extract and is achieved to reduce the intake of regular sugar yet providing the same level of sweetness and low-calorie intake which can help in weight management goals.

Example 5 (Slim Fit): Sugar substitute composition enriched with natural plant extracts and prebiotic fiber which reduces the consumption of sugar and helps in managing and keeping away obesity and diabetes and in improving the overall health was prepared using the following amount and process parameters as follows:

| Raw Materials | Quantity for 2 Kg | |
|---|---|---|
| Refined Sugar | 1944 | g |
| Herbs | 10 | g |
| Soluble Fibre | 40 | g |
| Stevia | 6 | g |
| Total | 2000 | g |

### Process Parameters:

Coating Drum: RPM 220-240
Peristaltic Spraying Pump: pipe tube wall thickness 1.5 mm, RPM of Pump 40-42
Quantity of solution sprayed-10 ml, Time taken: 45 Sec
Water—10 ml

Further, the Process Flow to achieve the Slim Fit sugar composition is as follows:
Transfer required Quantity of Sugar to Coating drum
Premix (Stevia+Licorice) (14 g) was added slowly (time taken to taken to add 14 g=30 sec) and blend for 5 minutes (RPM 220-230)
Moistening of the sugar mixture in the coating drum was done using 10 ml of water in 45 sec using Spraying Pump
Polydextrose was added slowly (120 g in 2 min) to the sugar mixture in the coating drum and blended for 10 minutes (RPM 220-230)
Dry the sugar (65-70 C) till the moisture <0.5% of the weight
Anticaking agent—silicon dioxide was added and blended for 3 minutes
Immediate Packing and Sealing of the product was done in controlled atmosphere.

The resulting Slim Fit sugar substitute composition was evaluated for the nutritional value and the following results were achieved:

Nutritional information*
Serve size - 2.5 g (½ tsp)
Servings Per Pack - 400, (regular size - 200)

| | Per 100 g | % RDA per serve |
|---|---|---|
| Energy (kcal) | 398.24 | — |
| Protein (g) | <0.1 | 0.0 |
| Carbohydrates (g) | 99.56 | 0.91 |
| Total Sugar (g) | 97.95 | — |
| Added Sugars (g) | 97.52 | 4.88 |
| Dietary Fibre (g) | 2.67 | 0.24 |
| Total Fat (g) | <0.05 | 0.0 |

*Approximate value when packed
% RDA values are calculated on the basis of 2000 calories a daily diet

Advantageously, the Slim Fit sugar substitute composition with natural plant extract is disclosed to reduce the intake of regular sugar yet providing the same level of sweetness and low-calorie intake which will help in fighting obesity and keep us healthier and in good shape.

Further, Dia Fit, Family Fit and Slim Fit sugar substitute compositions were also evaluated for the glycemic index and the following results were achieved:

| Sugar substitute composition | Glycemic Index | LOQ |
|---|---|---|
| Example 3 (Dia Fit) | 51.14 | 40.0 |
| Example 4 (Family Fit) | 55.90 | 40.0 |
| Example 5 (Slim Fit) | 48.58 | — |

Hence, the disclosed sugar substitute compositions are also capable of reducing the ill-effects of consuming regular sugar. The sugar substitute composition according to present disclosure provides for health benefits of natural plant extracts and helps the body detox and rejuvenate. There will be a reduction in consumption of sugar as less quantity has to be used to get the same taste and it reduces 50% calories of sugar for the consumers and thus is diabetic friendly compared to normal sugar as it is made with a combination of sugar alcohol, fibers and regular sugar. Further, it has added magnesium to support bone health and dietary fiber promotes general health, wellbeing and aids weight loss by reducing the calorie intake.

The foregoing description of the invention has been set merely to illustrate the invention and is not intended to be limiting. Since the modifications of the disclosed embodiments incorporating the spirit and substance of the invention may occur to the person skilled in the art, the invention should be construed to include everything within the scope of the disclosure.

1. A sugar substitute composition comprising:
(a) 70 wt. % to 99.97 wt. % of at least one selected from regular sugar, maple syrup, and honey; and
(b) 0.03 wt % to 20 wt % at least one selected from herb extract, soluble fiber, natural sweetener, sugar alcohol, anti-caking agent, vitamins and minerals,
wherein the wt. % is based on the total weight of the composition.

2. The sugar substitute composition as claimed in claim 1, wherein the regular sugar refers to sulfur-free processed sugar.

3. The sugar substitute composition as claimed in claim 1, wherein the soluble fibers include natural gums, plant-based fiber and prebiotic fibers.

4. The sugar substitute composition as claimed in claim 3, wherein the soluble fibers are selected from gum Arabic, gum acacia, gum tragacanth, gum ghatti, fibers obtained from obtained from fenugreek or methi seeds, polydextrose.

5. The sugar substitute composition as claimed in claim 1, wherein the sugar alcohols are selected from erythritol, threitol, arabitol, xylitol, ribitol, mannitol, sorbitol.

6. The sugar substitute composition as claimed in claim 1, wherein the herbs or herb extracts are selected from licorice, punarnava, arjuna, ashwagandha, brahmi, tulsi, garcinia cambogia, Gymnema sylvestre cinnamon, black jeera, black pepper.

7. The sugar substitute composition as claimed in claim 1, wherein the minerals are selected from calcium, magnesium, potassium, chromium, phosphorus and vitamins are selected from vitamins C, A, K, E and B.

8. The sugar substitute composition as claimed in claim 7, wherein the vitamins are vitamin B9, vitamin B12 and vitamin D.

9. The sugar substitute composition as claimed in claim 1, wherein the minerals are selected from iron and zinc.

10. The sugar substitute composition as claimed in claim 1, further comprising trace elements are selected from chromium, selenium and manganese.

11. The sugar substitute composition as claimed in claim 10, wherein the trace elements are selected Magnesium oxide, Magnesium or Chromium premix.

12. The sugar substitute composition as claimed in claim 1, comprising
(a) 70 wt. % to 99.97 wt. % of at least one selected from regular sugar, maple syrup, and honey, and
(b) 0.03 wt % to 10 wt % of at least one selected from herb, soluble fiber, natural sweetener, sugar alcohol, anti-caking agent, vitamins and minerals,
wherein the wt. % is based on the total weight of the composition.

13. The sugar substitute composition as claimed in claim 1, comprising
(c) 70 wt. % to 99.97 wt. % of at least one selected from regular sugar, maple syrup, and honey, and
(d) 0.03 wt % to 5 wt % of at least one selected from herb, soluble fiber, natural sweetener, sugar alcohol, anti-caking agent, vitamins and minerals,
wherein the wt. % is based on the total weight of the composition.

14. The sugar substitute composition as claimed in claim 1, comprising
(d) 70 wt. % to 99 wt. % of at least one selected from regular sugar, maple syrup, and honey,
(e) 0.05 wt. % to 0.7 wt. % of at least one natural sweetener, and
(f) 1.0 wt. % to 15.0 wt. % of at least one soluble fiber,
wherein the wt. % is based on the total weight of the composition.

15. The sugar substitute composition as claimed in claim 1, comprising
(a) 70 wt. % to 95 wt. % of at least one selected from regular sugar, maple syrup, and honey,
(b) 0.05 wt. % to 0.7 wt. % of at least one natural sweetener, and
(c) 1.0 wt. % to 15.0 wt. % of at least one soluble fiber,
wherein the wt. % is based on the total weight of the composition.

16. The sugar substitute composition as claimed in claim 1, comprising
(a) 70 wt. % to 99 wt. % of at least one selected from regular sugar, maple syrup, and honey, 0.05 wt. % to 0.3 wt. % of the at least one natural sweetener,
(b) 1.0 wt. % to 15.0 wt. % of the at least one soluble fiber,
(c) 5.0 wt. % to 15.0 wt. % of the at least one sugar alcohol,
(d) 0.05 wt. % to 0.3 wt. % of the anti-caking agent,
(e) 0.05 wt. % to 0.5 wt. % of the at least one herb extract, and
(f) 0.01 wt. % to 0.6 wt. % of the at least one vitamin and minerals,
wherein the wt. % is based on the total weight of the composition.

17. The sugar substitute composition as claimed in claim 1, comprising
(h) 70 wt. % to 90 wt. % of at least one selected from regular sugar, maple syrup, and honey,
(i) 0.05 wt. % to 0.3 wt. % of the at least one natural sweetener,
(j) 1.0 wt. % to 15.0 wt. % of the at least one soluble fiber,
(k) 5.0 wt. % to 9.0 wt. % of the at least one sugar alcohol,
(l) 0.05 wt. % to 0.3 wt. % of the anti-caking agent,
(m) 0.05 wt. % to 0.2 wt. % of the at least one herb extract, and
(n) 0.2 wt. % to 0.6 wt. % of the at least one vitamin and minerals,
wherein the wt. % is based on the total weight of the composition.

18. The sugar substitute composition as claimed in claim 1, comprising
(a) 80 wt. % to 95 wt. % of at least one selected from regular sugar, maple syrup, and honey,
(b) 0.3 wt. % to 0.7 wt. % of the at least one natural sweetener,
(c) 4.0 wt. % to 8.0 wt. % of the at least one soluble fiber, and
(d) 0.1 wt. % to 0.4 wt. % of the at least one herb extract,
wherein the wt. % is based on the total weight of the composition.

19. The sugar substitute composition as claimed in claim 1, comprising
(a) 99.75 wt % Sugar; and
(b) 0.25 wt % herbs;
wherein the wt. % is based on the total weight of the composition.

20. The sugar substitute composition as claimed in claim 1, comprising
(a) 99.97 wt % Sugar; and
(b) 0.03 wt % of micronutrient premix;
wherein the wt. % is based on the total weight of the composition.

21. The sugar substitute composition as claimed in claim 1, comprising
(a) 97.20 wt % Sugar;
(b) 0.50 wt % herbs;
(c) 2 wt % soluble fiber; and
(d) 0.30 wt % natural sweetener;
wherein the wt. % is based on the total weight of the composition.

22. The sugar substitute composition as claimed in claim 1, comprising
(j) 97.10 wt % Sugar;
(k) 0.25 wt % herbs;
(l) 2.125 wt % soluble fiber;
(m) 0.30 wt % natural sweetener;
(n) 0.20 wt % anti-caking agent; and
(o) 0.096 wt % minerals;
wherein the wt. % is based on the total weight of the composition.

23. The sugar substitute composition as claimed in claim 1, comprising
(e) 91.72 wt % Sugar;
(f) 0.45 wt % herbs;
(g) 2.13 wt % soluble fiber;
(p) 0.30 wt % natural sweetener;
(q) 5 wt % sugar alcohol;
(r) 0.20 wt % anti-caking agent; and
(h) 0.20 wt % minerals;
wherein the wt. % is based on the total weight of the composition.

24. The sugar substitute composition as claimed in claim 1 in the form of pellets, caplets, tablets, dispersible tablets, powder.

25. A method for preparing the sugar substitute composition as claimed in claim 1, comprising the steps as follows:
(a) mixing at least one selected from herb extract, soluble fiber, natural sweetener, sugar alcohol, anti-caking agent, vitamins and minerals in batch or stepwise manner in a solvent to obtained a mixture solution;
(b) adding at least one selected from regular sugar, maple syrup, and honey with dm water the solution mixture obtained in step (a) to obtain a suspension, and
(c) spraying or sprinkling the suspension obtained in step (b) to obtain the sugar substitute composition.

26. The method as claimed in claim 25, further comprising the steps of drying the sugar substitute composition at temperatures less than equal to 60° C.

27. The method as claimed in claim 25, further comprising the step of granulation by dry slugging and de-granulation to obtain desired granules.

28. A kit comprising the sugar substitute composition as claimed in claim 1 and a package insert.
